(19) United States
(12) Patent Application Publication
(10) Pub. No.: US 2026/0097809 A1
(43) Pub. Date: Apr. 9, 2026

(54) REAR WHEEL STEERING APPARATUS

(71) Applicant: HYUNDAI MOBIS CO., LTD., Seoul (KR)

(72) Inventors: Kwang Yoon KIM, Yongin-si (KR); Sun Young CHEONG, Yongin-si (KR); Byoung Ook SON, Yongin-si, (KR); Soon Ho BAEK, Yongin-si (KR)

(73) Assignee: HYUNDAI MOBIS CO., LTD., Seoul (KR)

(21) Appl. No.: 19/246,895

(22) Filed: Jun. 24, 2025

(30) Foreign Application Priority Data
Oct. 8, 2024 (KR) 10-2024-0136815

(51) Int. Cl. B62D 7/15; B62D 15/02

(52) U.S. Cl. CPC B62D 7/159; B62D 7/1545; B62D 15/0225

(57) ABSTRACT

Disclosed is a rear wheel steering apparatus that easily measures an absolute position of a rear wheel steering system including a steering shaft and a drive motor. This apparatus includes a driving force generator providing a driving force, a gear-shaped drive pulley connected to the driving force generator, a gear-shaped driven pulley configured to rotate by receiving a driving force from the drive pulley, a first measurement unit including a rotating sub-gear engaged with the drive pulley and a first magnetic force generator generating a magnetic field variation as the sub-gear rotates, a second measurement unit including a rotating main gear engaged with the driven pulley and a second magnetic force generator generating a magnetic field variation as the main gear rotates, and a printed circuit board detecting magnetic field variations of the first and second magnetic force generators and measuring steering angles of the drive and driven pulleys.

### CROSS-REFERENCE TO RELATED APPLICATIONS

The present application claims priority and the benefit of Korean Patent Application No. 10-2024-0136815, filed on October 8, 2024, in the Korean Intellectual Property Office, the entire disclosure of which is incorporated herein by reference.

### TECHNICAL FIELD

The present disclosure relates to a rear wheel steering apparatus, and more particularly, to a rear wheel steering apparatus that measures an absolute position of a rear wheel steering system.

### BACKGROUND

A steering apparatus has evolved into a steer-by-wire type, which is not in direct mechanical connection with a steering wheel operated by a driver. As steer-by-wire technology has advanced, the technology related to a rear wheel steering (RWS) apparatus has also advanced. The rear wheel steering apparatus is included in an all-wheel steering (AWS) apparatus, which is capable of enhancing vehicle responsiveness and driving safety, and reducing a turning radius.

In general, a steering shaft has a structure coupled to a screw nut. A male screw pattern is formed on the steering shaft, and a female screw pattern that is engaged with the male screw pattern of the steering shaft is formed on the screw nut. In response to the rotation of the screw nut by a drive pulley connected to a drive motor, a driven pulley moves in the axial direction, and the steering shaft connected to the driven pulley steers the rear wheels of the vehicle.

In general, a linear position sensor (LPS) is used in the rear wheel steering apparatus of a vehicle to measure a position of the steering shaft. The LPS basically includes a sensor housing coupled to a system housing and a magnet holder coupled to the steering shaft. This imposes internal and external constraints on the system during packaging and presents an issue in that additional processing, such as thread formation or hole machining, is required for assembly.

The related art of the present disclosure is disclosed in Korean Patent Application Publication No. 10-2024-0114400 (published on July 24, 2024, and entitled “Rear wheel steering apparatus and control method thereof”).

### SUMMARY

Various aspects of the present disclosure are directed to providing a rear wheel steering apparatus that enables easy measurement of an absolute position of a rear wheel steering system including a steering shaft and a drive motor.

A rear wheel steering apparatus according to an aspect of the present disclosure includes a driving force generator configured to provide a driving force, a drive pulley connected to the driving force generator and configured to have a gear shape, a belt connected to and driven by the drive pulley, a driven pulley connected to and rotated by the belt and configured to rotate by receiving a driving force from the drive pulley, and configured to have a gear shape, a first measurement unit including a sub-gear, which is arranged on an inner side of the belt and configured to rotate in engagement with the drive pulley, and a first magnetic force generator configured to generate a magnetic field variation in response to rotation of the sub-gear, a second measurement unit including a main gear, which is arranged on an inner side of the belt and configured to rotate in engagement with the driven pulley, and a second magnetic force generator configured to generate a magnetic field variation in response to rotation of the main gear, and a printed circuit board configured to detect magnetic fields of the first and second magnetic force generators, respectively, and measure rotational angles of the drive pulley and the driven pulley.

The rear wheel steering apparatus may further include a gear cover unit configured to surround the sub-gear and the main gear, in which both the sub-gear and the main gear are rotatably mounted.

The gear cover unit of the present disclosure may include a cover body provided with a coupling groove into which the sub-gear and the main gear are inserted and a cover positioning protrusion configured to determine a position of the cover body so that the cover body is arranged between the drive pulley and the driven pulley. The cover positioning protrusion may be mounted on a pulley cover surrounding the drive pulley and the driven pulley.

The first magnetic force generator of the present disclosure may include a sub-gear magnet in which a position where north and south poles are divided is arranged at a center of the sub-gear, and the second magnetic force generator of the present disclosure may include a main gear magnet in which a position where north and south poles are divided is arranged at a center of the main gear.

The sub-gear and the main gear of the present disclosure may be set to have different rotational speeds.

The printed circuit board of the present disclosure may include a sub-gear magnetic element configured to detect a magnetic field variation of the sub-gear magnet and a main gear magnetic element configured to detect a magnetic field variation of the main gear magnet.

The sub-gear magnetic element, the sub-gear, and the sub-gear magnet of the present disclosure may be coaxially arranged, and the main gear magnetic element, the main gear, and the main gear magnet of the present disclosure may be coaxially arranged.

The sub-gear and the main gear of the present disclosure may be arranged to intersect a center line, which is an imaginary line that connects central axes of the drive pulley and the driven pulley.

The rear wheel steering apparatus may further include a control unit configured to calculate a rear wheel steering angle at the start of vehicle operation, based on measured values from the sub-gear magnetic element and the main gear magnetic element.

The control unit of the present disclosure may determine that the driven pulley is in an abnormal state if a second measurement value measured by the main gear magnetic element deviates from a set range relative to a first measurement value measured by the sub-gear magnetic element.

In the present disclosure, the rear wheel steering apparatus may measure the absolute position of the rear wheel steering system without additional processing.

In the present disclosure, the package of the rear wheel steering apparatus may be optimized.

In the present disclosure, the rear wheel steering apparatus may not require additional processing, allowing manufacturing costs to be reduced.

In the present disclosure, the rear wheel steering apparatus may be applied to rear wheel steering systems of different specifications.

In the present disclosure, the rear wheel steering apparatus may identify a fault condition in the rear wheel steering system.

### BRIEF DESCRIPTION OF THE DRAWINGS

FIG. 1 is a view illustrating a configuration of a rear wheel steering apparatus according to an embodiment of the present disclosure.

FIG. 2 is a view illustrating portion A of FIG. 1.

FIG. 3 is a view of a first measurement unit of the rear wheel steering apparatus according to an embodiment of the present disclosure.

FIG. 4 is a view of a second measurement unit of the rear wheel steering apparatus according to an embodiment of the present disclosure.

FIG. 5 is a perspective view of a gear cover unit of the rear wheel steering apparatus according to an embodiment of the present disclosure.

FIG. 6 is a side view of a gear cover unit of the rear wheel steering apparatus according to an embodiment of the present disclosure.

FIG. 7 is a view of a gear cover unit and a pulley cover of the rear wheel steering apparatus according to an embodiment of the present disclosure.

FIG. 8 is a view of a first measurement unit and a second measurement unit of the rear wheel steering apparatus according to an embodiment of the present disclosure.

FIG. 9 is a view of a first measurement unit and a second measurement unit of a rear wheel steering apparatus according to another embodiment of the present disclosure.

FIG. 10 is a block diagram of a control unit of the rear wheel steering apparatus according to an embodiment of the present disclosure.

FIG. 11 is a flowchart of a control method of the rear wheel steering apparatus according to an embodiment of the present disclosure.

### DETAILED DESCRIPTION

An embodiment of a rear wheel steering apparatus according to the present disclosure will be described below with reference to the contents described in the accompanying drawings. However, the present disclosure is not limited or restricted to the exemplary embodiments.

In this process, the thickness of lines and the size of components illustrated in the drawing may be exaggerated for convenience. In addition, the terms used below are defined in consideration of the functions thereof in the present disclosure and may vary depending on the intention of a user or an operator or common practice. Therefore, the definitions of such terms should be made based on the content set forth throughout the present specification.

Furthermore, in this specification, when a part is described as being “connected (or linked)” to another part, this includes not only cases where it is "directly connected (or linked)," but also cases where it is "indirectly connected (or linked)” to another part with an intermediate member in between. When a part is referred to as “comprising (or having)” a certain component, it means that, unless specifically stated otherwise, it does not exclude other components but may further "comprise (or have)" other components.

The objects and effects of the present disclosure may be naturally understood or become more apparent from the description below, and the objects and effects of the present disclosure are not limited to the description below. In addition, in the description of the present disclosure, detailed descriptions of well-known technologies related to the present disclosure will be omitted when it is determined that such descriptions may unnecessarily obscure the gist of the present disclosure.

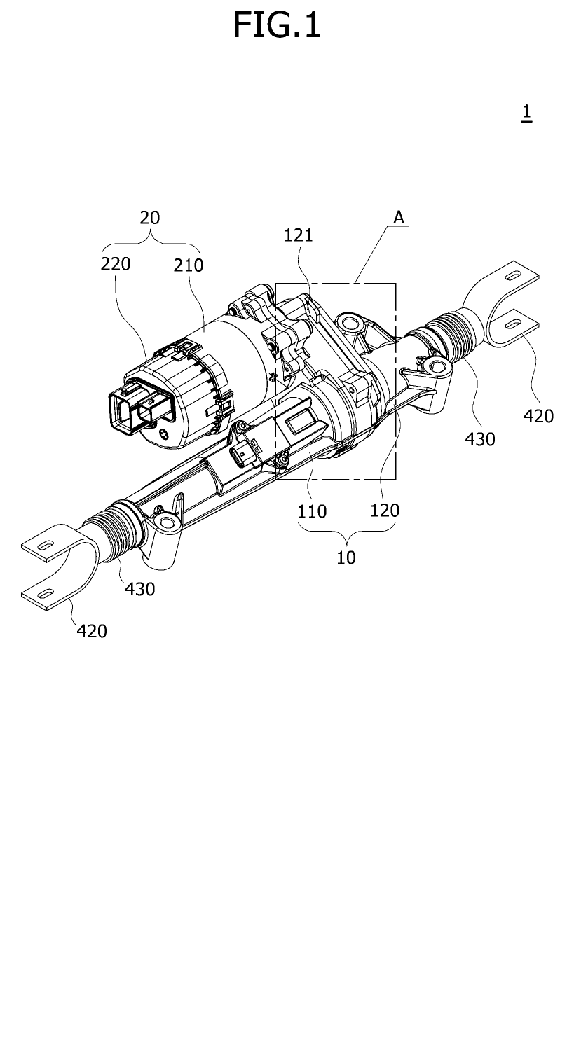

FIG. 1 is a view illustrating a configuration of a rear wheel steering apparatus according to an embodiment of the present disclosure.

Referring to FIG. 1, a rear wheel steering apparatus 1 according to an embodiment of the present disclosure may include a housing 10, a driving unit 20, a driving force transmission unit 30, and a steering unit 40.

The housing 10 may have a space formed therein, and the driving force transmission unit 30 and the steering unit 40 may be arranged in the housing 10.

The housing 10 may include a first housing 110 and a second housing 120. The first housing 110 and the second housing 120 may be coupled to each other to form a space therein. The first housing 110 may have the driving unit 20 arranged therein, or may have a space formed therein to allow the driving unit 20 to be inserted. In addition, the first housing 110 may have a space formed therein to allow the steering unit 40 to be arranged. The second housing 120 may have a space formed therein to allow the driving force transmission unit 30 and the steering unit 40 to be arranged.

The driving unit 20 may generate a driving force. The driving force may be rotational torque. The driving unit 20 may be arranged inside and/or outside the housing 10.

The driving unit 20 may include a driving force generator 210 that provides a driving force, and a driving force controller 220 that controls the driving force generator 210.

The driving force generator 210 may rotate in a first direction and in a second direction opposite to the first direction based on a signal transmitted from the driving force controller 220, and the rotational speed may vary. The driving force generator 210 may generate a driving force through rotation.

The driving force controller 220 may control the driving force generator 210 based on a steering signal from a driver operating a vehicle.

The driving unit 20 may be connected to the driving force transmission unit 30 arranged inside the housing 10. According to an embodiment, the driving force generator 210 may be connected to the driving force transmission unit 30 arranged inside the housing 10.

The driving force transmission unit 30 may be arranged inside the housing 10 and may receive a driving force from the driving unit 20. The driving force transmission unit 30 may transmit the driving force received from the driving unit 20 to the steering unit 40. The driving force transmission unit 30 may include a drive pulley 310, a driven pulley 330, and a belt 320.

The drive pulley 310 may be connected to the driving force generator 210 and rotate by the rotation of the driving force generator 210. The drive pulley 310 may be directly connected to the driving force generator 210. The drive pulley 310 may undergo axial rotation by the rotation of the driving force generator 210. For example, the driving force generator 210 may include a motor, and the drive pulley 310 may be coupled to a rotation shaft of the motor and rotate together with the rotation shaft of the motor.

Teeth or irregularities may be formed on an outer surface of the drive pulley 310. The drive pulley 310 and the belt 320 may be in contact with each other. The belt 320 may be engaged with the teeth or irregularities formed on the outer surface of the drive pulley 310 and move in response to the rotation of the drive pulley 310.

The driven pulley 330 may be arranged spaced apart from the drive pulley 310. The driven pulley 330 may rotate. According to an embodiment, the driven pulley 330 may undergo axial rotation. According to an embodiment, the rotational center axis of the driven pulley 330 may be parallel to the rotational center axis of the drive pulley 310 (e.g., the rotation shaft of the motor).

Teeth or irregularities may be formed on an outer surface of the driven pulley 330. The driven pulley 330 and the belt 320 may be in contact with each other. The belt 320 may be engaged with the teeth or irregularities formed on the outer surface of the driven pulley 330 and rotate in response to the movement of the driven pulley 330.

The belt 320 may be connected to the drive pulley 310 and the driven pulley 330. According to an embodiment, the belt 320 may be in contact with the outer surface of the drive pulley 310 and the outer surface of the driven pulley 330. Teeth or irregularities may be formed on an inner surface of the belt 320. The teeth or irregularities formed on the inner surface of the belt 320 may be engaged with the teeth or irregularities formed on the outer surface of the drive pulley 310 and the teeth or irregularities formed on the outer surface of the driven pulley 330.

As such, as the belt 320 is engaged with the drive pulley 310 and the driven pulley 330, the driving force generated by the driving unit 20 may be transmitted to the driven pulley 330 through the drive pulley 310 and the belt 320. The driven pulley 330 may rotate through the driving force transmitted via the belt 320.

The rear wheel steering apparatus 1 according to an embodiment of the present disclosure may further include a steering unit 40 that performs linear motion in an axial direction using the driving force received from the driving force transmission unit 30.

The steering unit 40 may include a lead screw shaft 410, an end module 420, and a foreign matter blocking portion 430.

The lead screw shaft 410 may be arranged inside the housing 10 and move along the axial direction by the driving force. As the lead screw shaft 410 performs linear motion, a steering angle of a vehicle wheel connected to the steering unit 40 may be adjusted.

The lead screw shaft 410 may be arranged inside the housing 10 and extend in a direction parallel to one direction (e.g., X-axis direction). The lead screw shaft 410 may move in a direction parallel to one direction (e.g., X-axis direction).

The end module 420 may be arranged at an end portion (e.g., in the X-axis direction) of the lead screw shaft 410. The end module 420 may be connected to a wheel of the vehicle and move in response to the movement of the lead screw shaft 410 to change a steering angle of the vehicle wheel.

The foreign matter blocking portion 430 may be arranged between the housing 10 and the end module 420. The foreign matter blocking portion 430 may prevent foreign matter from entering the inside of the rear wheel steering apparatus 1. The foreign matter blocking portion 430 may have a corrugated shape. According to an embodiment, the foreign matter blocking portion 430 may have a bellows shape. Accordingly, as the foreign matter blocking portion 430 has a corrugated shape, the length of the foreign matter blocking portion 430 may vary. As the steering unit 40 moves, the end module 420 may move away from the housing 10, and the distance between the end module 420 and the housing 10 may vary. As the foreign material blocking unit 430, which has a variable length, is arranged between the end module 420 and the housing 10, the airtightness and/or waterproofness of the rear wheel steering apparatus 1 may be improved. Accordingly, foreign matter may be prevented from entering the inside of the rear wheel steering apparatus 1.

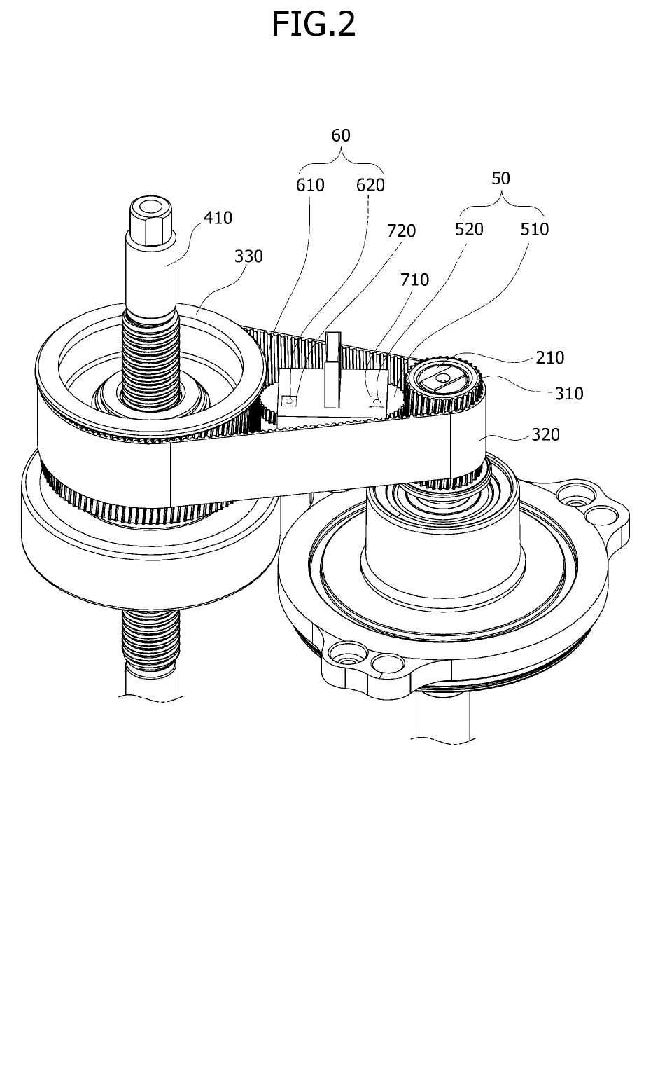

FIG. 2 is a view illustrating portion A of FIG. 1.

Referring to FIG. 2, the rear wheel steering apparatus 1 according to an embodiment of the present disclosure may include the driving force generator 210, the drive pulley 310, a first measurement unit 50, a second measurement unit 60, and a printed circuit board 70.

The driving force generator 210 provides a driving force. The drive pulley 310 connected to the driving force generator 210 may have a gear shape. The belt 320 may be connected to and driven by the drive pulley 310. The driven pulley 330 may be connected to and rotated by the belt 320, rotate by receiving a driving force from the drive pulley 310, and have a gear shape.

The first measurement unit 50 may include a sub-gear 510, which is arranged on an inner side of the belt 320 and rotates in engagement with the drive pulley 310, and a first magnetic force generator 520 configured to generate a magnetic field variation in response to the rotation of the sub-gear 510.

The first measurement unit 50 may be arranged on a side of the drive pulley 310 and measure a steering angle of the drive pulley 310. As the sub-gear 510 rotates in conjunction with the rotation of the drive pulley 310, the first measurement unit 50 may measure the steering angle of the drive pulley 310.

The sub-gear 510 may rotate in engagement with the drive pulley 310. The sub-gear 510 may have gear teeth formed to correspond to the outer surface on which the teeth of the drive pulley 310 are formed. The drive pulley 310 may be engaged with the sub-gear 510 to transmit rotation and power from a drive shaft of the drive pulley 310 to a driven shaft of the sub-gear 510.

The sub-gear 510 may be arranged on a side of the drive pulley 310. Specifically, the sub-gear 510 may be arranged between the driven pulley 330, which will be described below, and the drive pulley 310.

The sub-gear 510 may include a disk-shaped body of the sub-gear 510 and teeth of sub-gear 510 surrounding the body of the sub-gear 510. The diameter of the sub-gear 510 is not limited, but may be formed smaller than the diameter of the drive pulley 310 so that a small rotational force of the drive pulley 310 may be easily transmitted to the sub-gear 510.

The first magnetic force generator 520 may be fixedly mounted on the sub-gear 510. For example, the first magnetic force generator 520 may be mounted and fixed in a magnet mounting groove 511 formed in the body of the sub-gear 510.

The first magnetic force generator 520 may include a sub-gear magnet 521 in which the position where the north (N) and south (S) poles are divided is arranged at the center of the sub-gear 510.

Specifically, the first magnetic force generator 520 may pass through the center of the sub-gear 510. The first magnetic force generator 520 may be press-fitted into the center of the sub-gear 510.

The sub-gear magnet 521 may be a permanent magnet. The sub-gear magnet 521 may include divided N pole and S pole regions.

The second measurement unit 60 may include a main gear 610, which is arranged on an inner side of the belt 320 and rotates in engagement with the driven pulley 330, and a second magnetic force generator 620 configured to generate a magnetic field variation in response to the rotation of the main gear 610.

The second measurement unit 60 may be arranged on a side of the driven pulley 330 and may measure a steering angle of the driven pulley 330. As the main gear 610 rotates in conjunction with the rotation of the driven pulley 330, the second measurement unit 60 may measure the steering angle of the driven pulley 330.

The main gear 610 may rotate in engagement with the driven pulley 330. The main gear 610 may have gear teeth formed to correspond to the outer surface on which the teeth of the driven pulley 330 are formed. The driven pulley 330 may be engaged with the main gear 610 to transmit rotation and power from a drive shaft of the driven pulley 330 to a driven shaft of the main gear 610.

The main gear 610 may be arranged on a side of the driven pulley 330. Specifically, the main gear 610 may be arranged between the drive pulley 310 and the driven pulley 330. The main gear 610 may be arranged on a side of the sub-gear 510.

The main gear 610 may be arranged spaced apart from the sub-gear 510. Due to the presence of a distance between the main gear 610 and the sub-gear 510, the main gear 610 and the sub-gear 510 may not be engaged with each other and may rotate independently.

The sub-gear 510 and the main gear 610 may be configured to have different rotational speeds. Specifically, the gear ratio of the sub-gear 510 and the main gear 610 may be differently set. The sub-gear 510 and the main gear 610 may have different numbers of gear teeth. Accordingly, the sub-gear 510 and the main gear 610 may have different rotation ratios.

The sub-gear 510 and the main gear 610, which have different gear ratios, may be configured to have different rotational speeds. Accordingly, a difference in the magnetic field signal values between the sub-gear 510 and the main gear 610 may be generated. Due to the difference in signal values, an absolute angle of the steering angles of the drive pulley 310, which rotates in engagement with the sub-gear 510, and the driven pulley 330, which rotates in engagement with the main gear 610, may be calculated.

The second magnetic force generator 620 may be fixedly mounted on the main gear 610. For example, the second magnetic force generator 620 may be mounted and fixed in a magnet mounting groove 611 formed in a body of the main gear 610.

The second magnetic force generator 620 may include a main gear magnet 621 in which the position where the N and S poles are divided is arranged at the center of the main gear 610.

Specifically, the second magnetic force generator 620 may pass through the center of the main gear 610. The second magnetic force generator 620 may be press-fitted into the center of the main gear 610.

The main gear magnet 621 may be a permanent magnet. The main gear magnet 621 may include divided N pole and S pole regions.

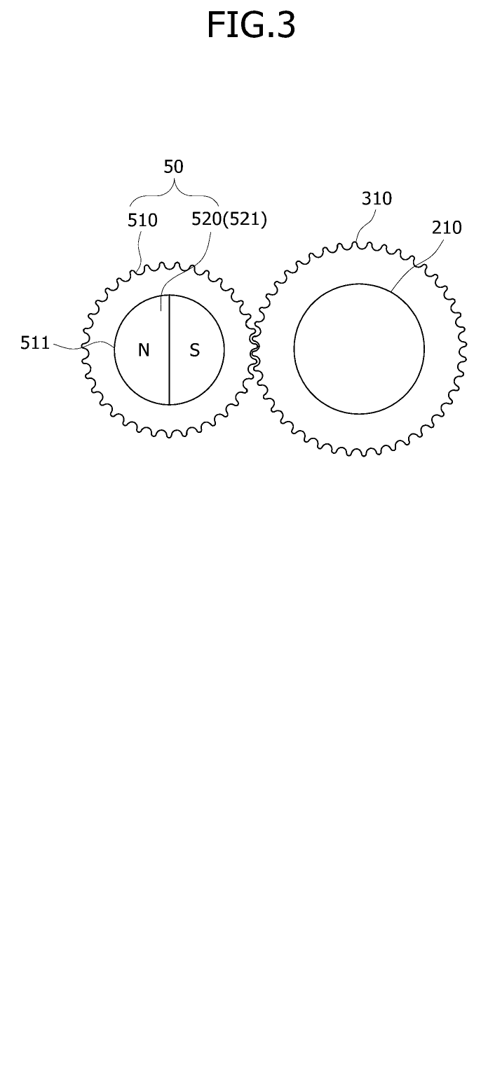

FIG. 3 is a view of a first measurement unit of the rear wheel steering apparatus according to an embodiment of the present disclosure.

Referring to FIG. 3, the first measurement unit 50 rotates in engagement with the drive pulley 310. For example, the sub-gear 510 may rotate counterclockwise in response to the clockwise rotation of the drive pulley 310. At this point, the rotation of the sub-gear magnet 521, which is coupled to the sub-gear 510, causes a magnetic field variation.

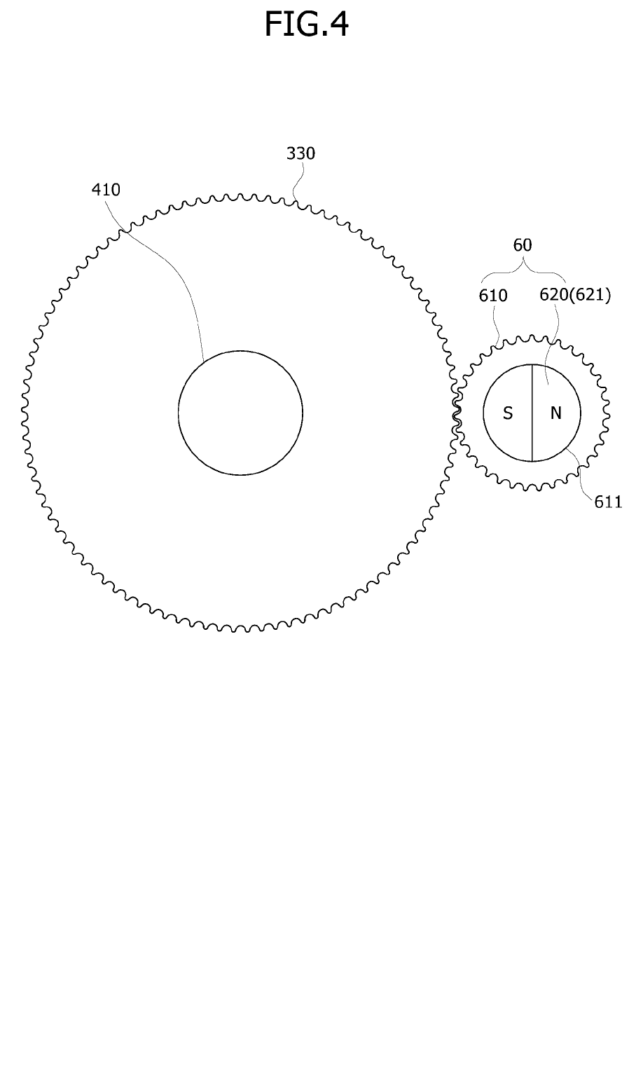

FIG. 4 is a view of a second measurement unit of the rear wheel steering apparatus according to an embodiment of the present disclosure.

Referring to FIG. 4, the second measurement unit 60 rotates in engagement with the driven pulley 330. For example, the main gear 610 may rotate counterclockwise in response to the clockwise rotation of the drive pulley 330. At this point, the rotation of the main gear magnet 621, which is coupled to the main gear 610, causes a magnetic field variation.

As the sub-gear magnet 521 and the main gear magnet 621 rotate, the positions of the N and S poles change, respectively. Such information on the changes in the positions of the N and S poles may be transmitted to the printed circuit board 70.

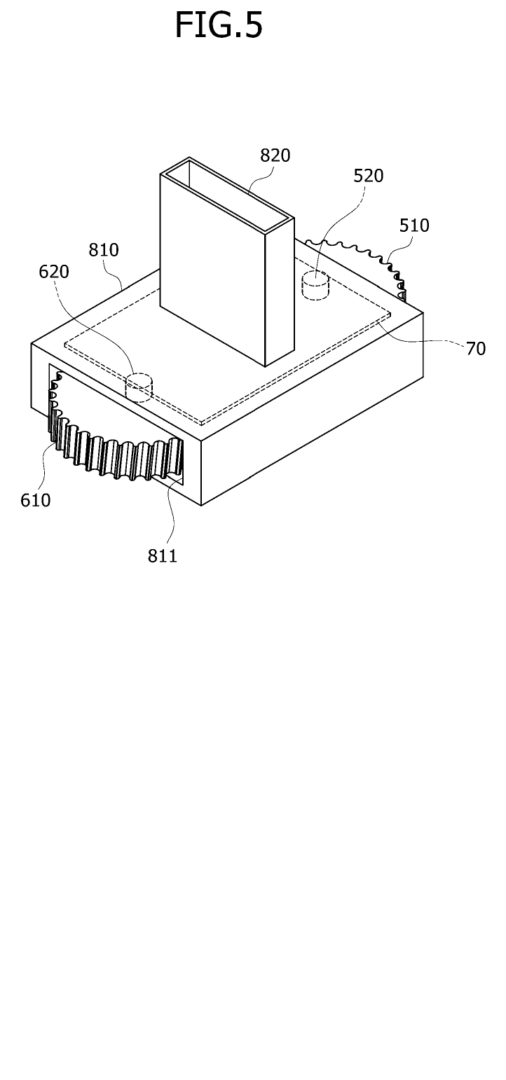

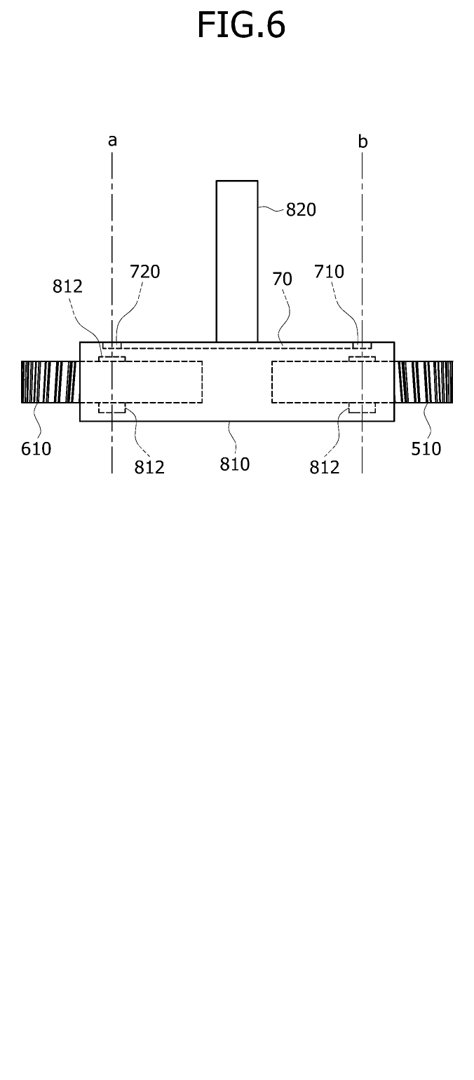

FIG. 5 is a perspective view of a gear cover unit of the rear wheel steering apparatus according to an embodiment of the present disclosure. FIG. 6 is a side view of a gear cover unit of the rear wheel steering apparatus according to an embodiment of the present disclosure.

Referring to FIG. 5, the rear wheel steering apparatus 1 according to an embodiment of the present disclosure may further include a gear cover unit 80 that protects the sub-gear 510 and the main gear 610, and includes a coupling groove 811 corresponding to the thickness and width of the sub-gear 510 and the main gear 610 so that the positions of the sub-gear 510 and the main gear 610 are fixed.

The gear cover unit 80 may further include a cover body 810 that surrounds the sub-gear 510 and the main gear 610, in which both the sub-gear 510 and the main gear 610 are rotatably mounted.

The gear cover unit 80 may protect the sub-gear 510 and the main gear 610 from the outside and prevent foreign matter from entering the inside of the sub-gear 510 and the main gear 610. In the present embodiment, the gear cover unit 80 is illustrated as having a cuboid shape, but the present disclosure is not limited thereto and is subject to various modifications.

The gear cover unit 80 may include a cover body 810, which has an engagement groove 811 into which the sub-gear 510 and the main gear 610 are inserted, and a cover positioning protrusion 820, which determines a position of the cover body 810 so that the cover body 810 is arranged between the drive pulley 310 and the driven pulley 330.

The coupling groove 811 is a space into which the sub-gear 510 and the main gear 610 are inserted. The coupling groove 811 may prevent the sub-gear 510 and the main gear 610 from disengaging from the rotational shaft.

Referring to FIG. 6, the cover body 810 may further include a bearing 812 that rotatably supports the sub-gear 510 and the main gear 610.

The bearing 812 supports the sub-gear 510 and the main gear 610 in the vertical direction inside the cover body 810, such that the sub-gear 510 and the main gear 610 may rotate in conjunction with the rotation of the drive pulley 310 and the driven pulley 330, respectively and independently.

The cover positioning protrusion 820 may extend from a surface of the cover body 810. The cover positioning protrusion 820 may connect the cover body 810 and a pulley cover 121. The pulley cover 121 may be provided in the second housing 120. The pulley cover 121 may surround and protect the drive pulley 310 and the driven pulley 330.

The cover positioning protrusion 820 may adjust the positions of the sub-gear 510 and the main gear 610 so that the sub-gear 510 and the main gear 610 may be engaged with the drive pulley 310 and the driven pulley 330. The sub-gear 510 and the main gear 610 are fixed to the cover body 810, but the cover positioning protrusion 820 may determine the position of the cover body 810 so that the sub-gear 510 and the main gear 610 are engaged with the drive pulley 310 and the driven pulley 330.

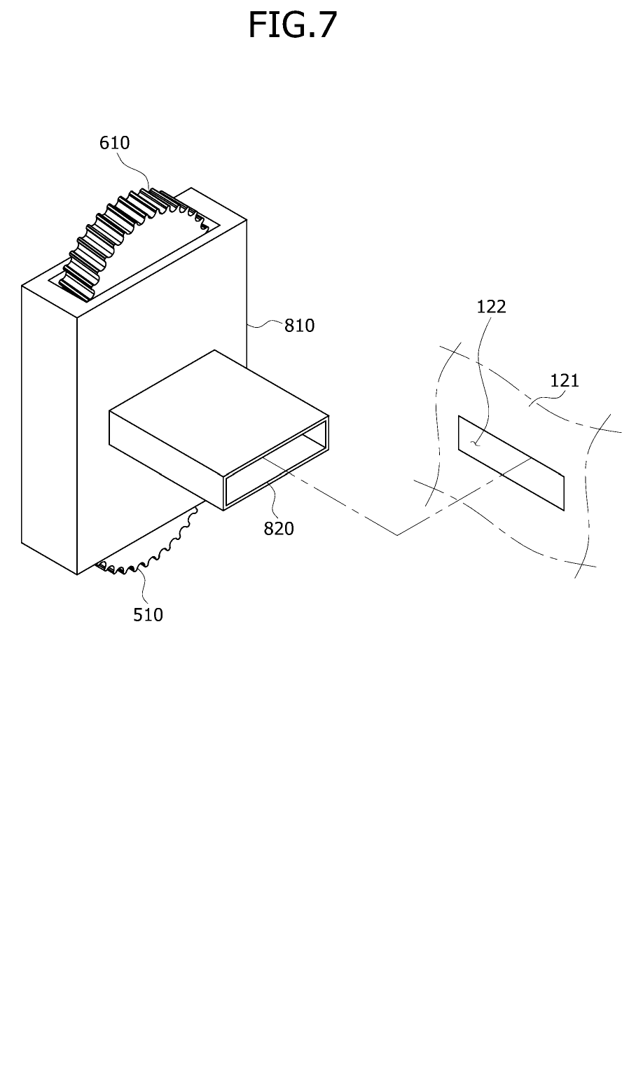

FIG. 7 is a view of a gear cover unit and a pulley cover of the rear wheel steering apparatus according to an embodiment of the present disclosure.

Referring to FIG. 7, the cover positioning protrusion 820 may be mounted on the pulley cover 121 that surrounds the drive pulley 310 and the driven pulley 330. As the cover positioning protrusion 820 is inserted into a protrusion groove 122 formed in the pulley cover 121, the gear cover unit 80 and the second housing 120 may be temporarily coupled. In the temporarily coupled state of the gear cover unit 80 and the second housing 120, the positions of the sub-gear 510 and the main gear 610 may be determined so that they are respectively engaged with the drive pulley 310 and the driven pulley 330.

The protrusion groove 122 may be formed to have the same width and length as the cover positioning protrusion 820 so as to correspond to the cover positioning protrusion 820.

Referring to FIG. 6, the printed circuit board 70 may detect the magnetic fields of the first magnetic field generator 520 and the second magnetic field generator 620, respectively, and measure the rotation angles of the drive pulley 310 and the driven pulley 330.

The printed circuit board 70 may be mounted inside the cover body 810. The printed circuit board 70 may be a printed circuit board (PCB). The printed circuit board 70 is a board that mechanically supports and electrically connects electronic components. Transistors, capacitors, and the like may be provided in the printed circuit board 70.

The printed circuit board 70 may include a sub-gear magnetic element 710 that detects a magnetic field variation of the sub-gear magnet 521 and a main gear magnetic element 720 that detects a magnetic field variation of the main gear magnet 621.

The sub-gear magnetic element 710 may detect a magnetic field variation generated by the rotation of the sub-gear magnet 521, which is coupled to the sub-gear 510, and transmit a signal value to a control unit 90.

The main gear magnetic element 720 may detect a magnetic field variation generated by the rotation of the main gear magnet 621, which is coupled to the main gear 610, and may transmit a signal value to the control unit 90.

Referring to FIG. 6, the sub-gear magnetic element 710, the sub-gear 510, and the sub-gear magnet 521 may be coaxially arranged, and the main gear magnetic element 720, the main gear 610, and the main gear magnet 621 may be coaxially arranged.

The sub-gear magnetic element 710, the sub-gear 510, and the sub-gear magnet 521 may be arranged along the a-axis, and the main gear magnetic element 720, the main gear 610, and the main gear magnet 621 may be arranged along the b-axis.

Accordingly, as the sub-gear 510 rotates, the sub-gear magnetic element 710, whose central axis is aligned with the sub-gear magnet 521 in the vertical direction, may detect a magnetic field variation generated by the sub-gear magnet 521. The sub-gear magnetic element 710 may transmit a signal value to the control unit 90.

As the main gear 610 rotates, the main gear magnetic element 720, whose central axis is aligned with the main gear magnet 621 in the vertical direction, may detect a magnetic field variation generated by the main gear magnet 621. The main gear magnetic element 720 may transmit a signal value to the control unit 90.

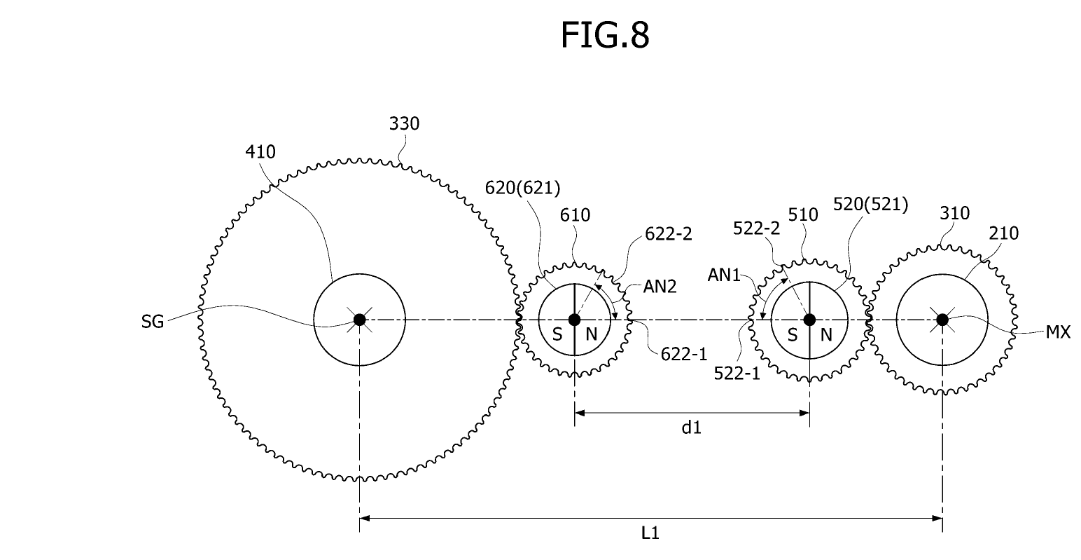

FIG. 8 is a view of a first measurement unit and a second measurement unit of the rear wheel steering apparatus according to an embodiment of the present disclosure.

Referring to FIG. 8, the first measurement unit 50 and the second measurement unit 60 may be arranged on a center line that connects the centers of the drive pulley 310 and the driven pulley 330. If the first measurement unit 50 and the second measurement unit 60 are arranged side by side on the center line of the drive pulley 310 and the driven pulley 330, the main gear magnetic element 720 and the sub-gear magnetic element 710, which are mounted on the printed circuit board 70, may also be arranged side by side on the center line.

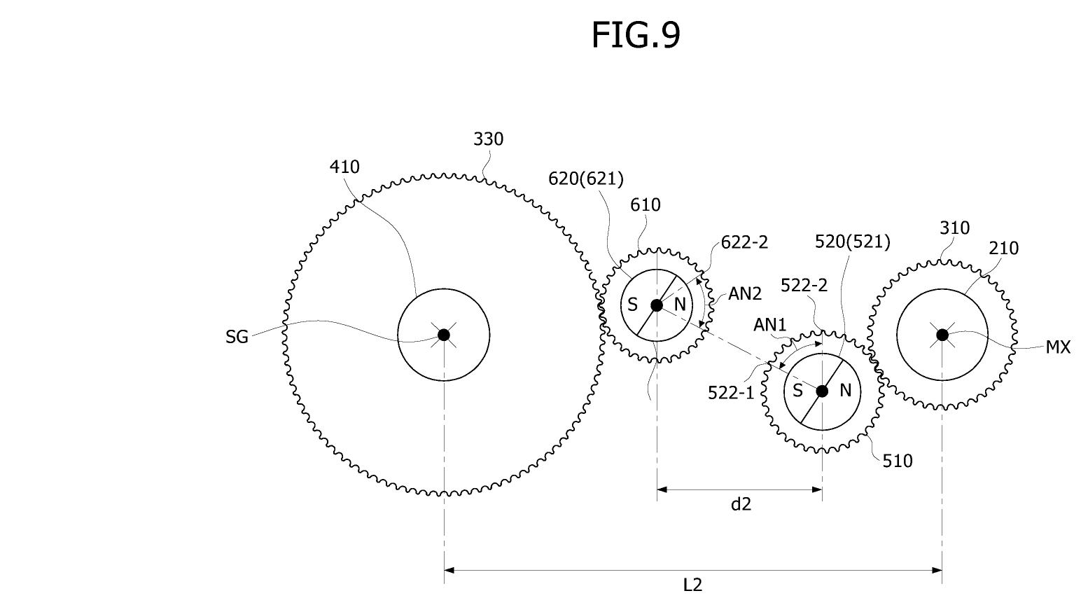

FIG. 9 is a view of a first measurement unit and a second measurement unit of a rear wheel steering apparatus according to another embodiment of the present disclosure.

Referring to FIG. 9, the sub-gear 510 and the main gear 610 may be arranged to intersect a center line, which is an imaginary line that connects the central axes of the drive pulley 310 and the driven pulley 330.

If the sub-gear 510 and the main gear 610 are arranged offset from the center line of the drive pulley 310 and the driven pulley 330, the distance between the sub-gear 510 and the main gear 610 may be configured to be shorter.

Referring to FIG. 8, if the distance between the drive pulley 310 and the driven pulley 330 is defined as L1, the first measurement unit 50 and the second measurement unit 60 may be spaced d1 apart. In contrast, as shown in FIG. 9, if the drive pulley 310 and the driven pulley 330 are to be spaced L2 apart, which is shorter than L1, the first measurement unit 50 and the second measurement unit 60 may be spaced d2 apart, which is shorter than d1. d2 is the shortest distance between the positions where lines perpendicular to L2 intersect the sub-gear 510 and the main gear 610, respectively. Accordingly, even if the specifications of the drive pulley 310 and the driven pulley 330 differ and the sub-gear 510 and the main gear 610 cannot be arranged side by side as shown in FIG. 8, the steering angle may be calculated by arranging the sub-gear 510 and the main gear 610 offset from the center line as shown in FIG. 9.

An example of a method for measuring a steering angle of a rear wheel will be described with reference to FIGS. 8 and 9. If a reference point 522-1 set on an outer circumferential surface of the sub-gear 510 comes into contact with a reference point 622-1 set on an outer circumferential surface of the main gear 610, the rear wheel steering angle may be 0° relative to the longitudinal direction of the vehicle.

In the embodiments shown in FIGS. 8 and 9, the number of gear teeth of the sub-gear 510 differs from that of the main gear 610. Accordingly, if the rear wheel steering angle changes due to the rotation of the driving force generator 210, the reference point of the sub-gear 510 rotates clockwise by a first angle AN1 about the axis MX of the driving force generator 210, and moves to position 522-2.

Similarly, a reference point 622-1 of the main gear 610 may rotate counterclockwise by a second angle AN2 about the axis SG of the lead screw shaft 410 and move to position 622-2.

The rear wheel steering angle may be determined based on the relationship between the first angle AN1 and the second angle AN2. For example, as the value obtained by subtracting the first angle AN1 from the second angle AN2 increases, the rear wheel steering angle may increase. Accordingly, a magnetic field variation of the first magnetic field generator 520 and the second magnetic field generator 620 provides information on the rotation angles of the sub-gear 510 and the main gear 610. By measuring the rotation angles of the sub-gear 510 and the main gear 610, the rotation angles of the drive pulley 310 and the driven pulley 330 may be determined, and the rear wheel steering angle may be calculated.

If the rear wheel steering angle is measured using this method, the rear wheel steering angle may be calculated at the time of initiating vehicle operation, that is, at the start of vehicle operation.

Specifically, if the vehicle operation is terminated by turning off the power switch in a state where the rear wheel steering angle is not aligned to 0°, and the vehicle operation is subsequently restarted by turning the power switch back on, the rear wheel steering angle may be measured at the start of vehicle operation and notified to the driver. This may assist the driver in safely operating the vehicle.

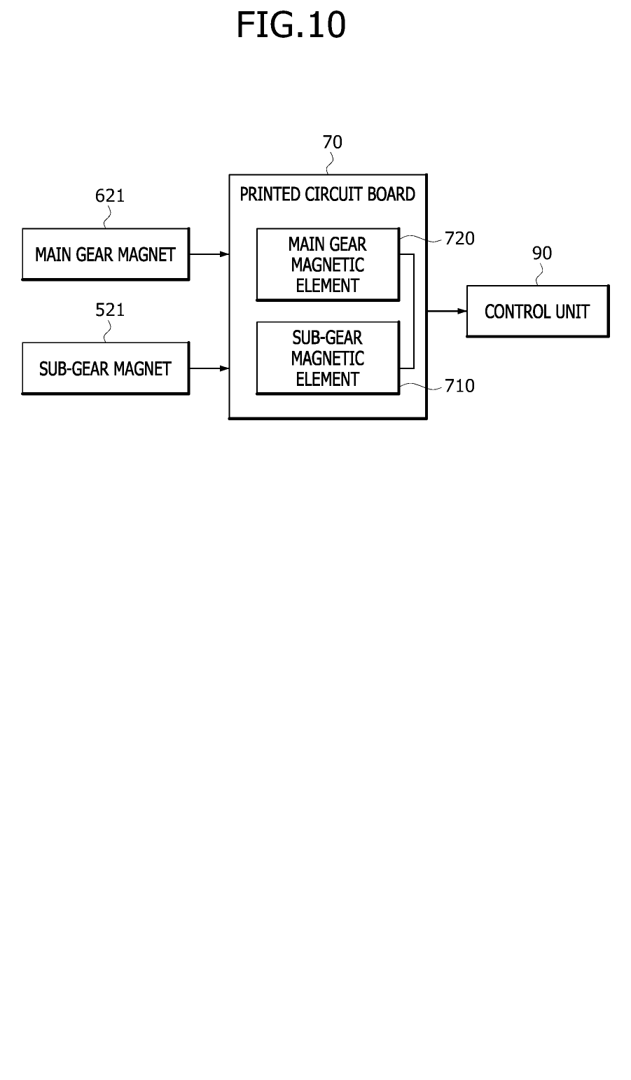

FIG. 10 is a block diagram of a control unit of the rear wheel steering apparatus according to an embodiment of the present disclosure.

Referring to FIG. 10, the rear wheel steering apparatus 1 according to an embodiment of the present disclosure may further include a control unit 90 configured to calculate a rear wheel steering angle at the start of vehicle operation, based on the measured values from the sub-gear magnetic element 710 and the main gear magnetic element 720.

The control unit 90 may be an electronic control unit (ECU). The control unit 90 may perform real-time management of the vehicle body condition by analyzing data collected from sensors. In the present embodiment, the control unit 90 may calculate a rear wheel steering angle based on signal values received from the printed circuit board 70, on which the sub-gear magnetic element 710 and the main gear magnetic element 720 are mounted.

Specifically, the main gear magnetic element 720 detects a magnetic field variation from the main gear magnet 621, and the sub-gear magnetic element 710 detects a magnetic field variation from the sub-gear magnet 521. Signal values generated by the main gear magnetic element 720 and the sub-gear magnetic element 710 may be transmitted to the control unit 90, which allows the control unit 90 to calculate the steering angles of the main gear 610 and the sub-gear 510 as absolute angles.

As the main gear 610 is connected to the driven pulley 330, and the driven pulley 330 is connected to the lead screw shaft 410, the steering angle of the main gear 610 corresponds to the steering angle of the lead screw shaft 410.

As the sub-gear 510 is connected to the drive pulley 310, and the drive pulley 310 is connected to the driving force generator 210, the steering angle of the sub-gear 510 corresponds to the steering angle of the driving force generator 210.

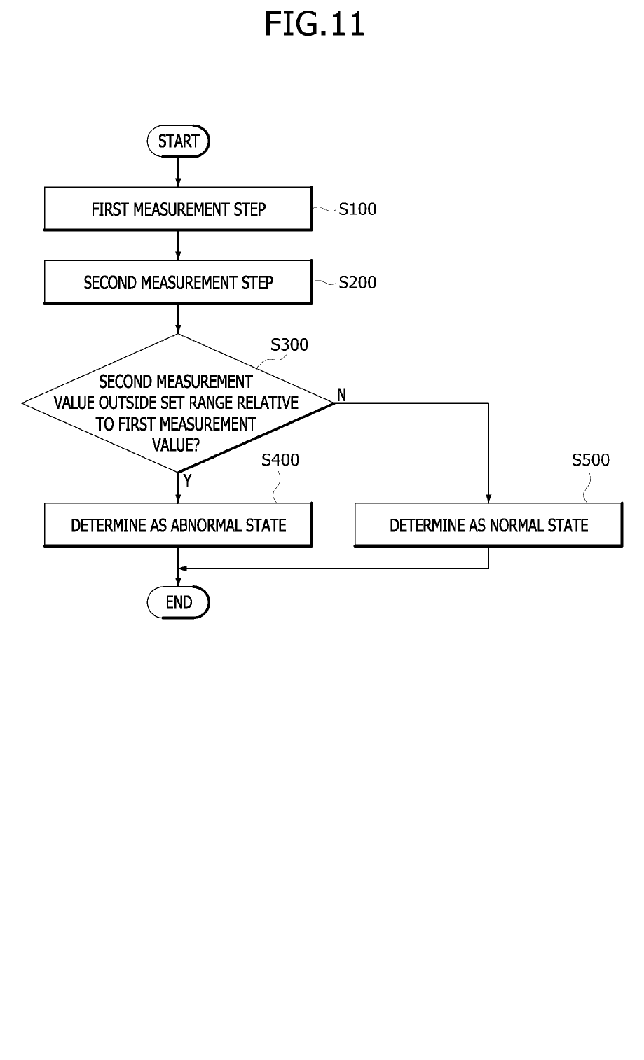

FIG. 11 is a flowchart of a control method of the rear wheel steering apparatus according to an embodiment of the present disclosure.

Referring to FIG. 11, the rear wheel steering apparatus 1 may compare a first measurement value measured in a first measurement step with a second measurement value measured in a second measurement step.

In the first measurement step, the sub-gear magnetic element 710 detects a magnetic field variation from the sub-gear magnet 521. The sub-gear magnetic element 710 may transmit the first measurement value, which is the measured signal value, to the control unit 90 (S100).

In the second measurement step, the main gear magnetic element 720 detects a magnetic field variation from the main gear magnet 621. The main gear magnetic element 720 may transmit the second measurement value, which is the measured signal value, to the control unit 90 (S200).

The control unit 90 may calculate the steering angles of the main gear 610 and the sub-gear 510 as absolute angles by computing the difference between the first measurement value and the second measurement value measured in the first and second measurement steps, respectively (S300).

If the second measurement value is outside a set range relative to the first measurement value, it may be determined as an abnormal state (S400). In contrast, if the second measurement value is within the set range relative to the first measurement value, it may be determined as a normal state (S500). The set range may be defined as the absolute angle of the rear wheel steering angle, based on the second measurement value relative to the first measurement value at the start of vehicle operation.

The first and second measurement steps are not restricted to a specific order, and the first measurement step may be performed following the second measurement step.

If a slip occurs between the belt 320 and the driven pulley 330, or if the elasticity of the belt 320 decreases, the second measurement value may be derived as higher or lower than the first measurement value. Accordingly, if the second measurement value that deviates from the set range relative to the first measurement value may be determined as an abnormal state indicating a fault condition.

The result value derived by the control unit 90 may be transmitted to the vehicle's ECU, thereby notifying the driver of a fault condition. This allows the driver to take follow-up actions required for the vehicle.

Although embodiments of the present disclosure have been described with reference to the accompanying drawings, these embodiments are for illustrative purposes only, and those skilled in the art will appreciate that various modifications and other equivalent embodiments can be made from these embodiments disclosed herein. Thus, the true technical scope of the present disclosure should be defined by the following claims.

What is claimed is:

1. A rear wheel steering apparatus comprising:
a driving force generator configured to provide a driving force;
a drive pulley having a first gear shape and connected to the driving force generator;
a belt connected to and driven by the drive pulley;
a driven pulley having a second gear shape, connected to and rotated by the belt, and receiving and rotated by a driving force from the drive pulley;
a first measurement unit including (1) a sub-gear arranged on an inner side of the belt and configured to rotate in engagement with the drive pulley, and (2) a first magnetic force generator configured to generate a first magnetic field variation in response to rotation of the sub-gear;
a second measurement unit including (1) a main gear arranged on the inner side of the belt and configured to rotate in engagement with the driven pulley, and (2) a second magnetic force generator configured to generate a second magnetic field variation in response to rotation of the main gear; and
a printed circuit board configured to detect magnetic fields of the first and second magnetic force generators, and measure rotational angles of the drive pulley and the driven pulley.

2. The rear wheel steering apparatus as claimed in claim 1, further comprising a gear cover unit surrounding the sub-gear and the main gear, wherein both the sub-gear and the main gear are rotatably mounted.

3. The rear wheel steering apparatus as claimed in claim 2, wherein the gear cover unit comprises:
a cover body having a coupling groove into which the sub-gear and the main gear are inserted; and
a cover positioning protrusion configured to determine a position of the cover body so that the cover body is arranged between the drive pulley and the driven pulley,
wherein the cover positioning protrusion is mounted on a pulley cover surrounding the drive pulley and the driven pulley.

4. The rear wheel steering apparatus as claimed in claim 1, wherein:
the first magnetic force generator includes a sub-gear magnet in which a first position where north and south poles of the sub-gear magnet are divided is arranged at a center of the sub-gear, and
the second magnetic force generator includes a main gear magnet, wherein a second position where north and south poles of the main gear magnet are divided is arranged at a center of the main gear.

5. The rear wheel steering apparatus as claimed in claim 4, wherein the sub-gear and the main gear are set to have different rotational speeds.

6. The rear wheel steering apparatus as claimed in claim 4, wherein the printed circuit board comprises:
a sub-gear magnetic element configured to detect a first magnetic field variation of the sub-gear magnet; and
a main gear magnetic element configured to detect a second magnetic field variation of the main gear magnet.

7. The rear wheel steering apparatus as claimed in claim 6, wherein:
the sub-gear magnetic element, the sub-gear, and the sub-gear magnet are coaxially arranged, and
the main gear magnetic element, the main gear, and the main gear magnet are coaxially arranged.

8. The rear wheel steering apparatus as claimed in claim 6, wherein the sub-gear and the main gear are arranged to intersect a center line, which is an imaginary line that connects central axes of the drive pulley and the driven pulley.

9. The rear wheel steering apparatus as claimed in claim 6, further comprising a control unit configured to calculate, based on measured values from the sub-gear magnetic element and the main gear magnetic element, a rear wheel steering angle at a start of vehicle operation.

10. The rear wheel steering apparatus as claimed in claim 9, wherein the control unit is configured to determine that the driven pulley is in an abnormal state if a second measurement value measured by the main gear magnetic element deviates from a set range relative to a first measurement value measured by the sub-gear magnetic element.
